(19) United States
(12) Patent Application Publication
(10) Pub. No.: US 2010/0053001 A1
(43) Pub. Date: Mar. 4, 2010

(54) ANTENNA CONNECTING MODULE CAPABLE OF REDUCING OCCUPIED SPACE AND PORTABLE ELECTRONIC DEVICE THEREOF

(76) Inventors: Yao-Ju Lu, Taipei (TW); Hsi-Yung Liu, Taipei (TW); Bo-Wei Chu, Taipei (TW)

Correspondence Address: NORTH AMERICA INTELLECTUAL PROPERTY CORPORATION, P.O. BOX 506, MERRIFIELD, VA, 22116, US

(21) Appl. No.: 12/479,863

(22) Filed: Jun. 8, 2009

(30) Foreign Application Priority Data
Sep. 2, 2008 (TW) 097133569

(51) Int. Cl. H01Q 1/50; H01Q 1/24

(52) U.S. Cl. 343/702; 343/906

(57) ABSTRACT

An antenna connecting module includes a printed circuit board, a metal pad, and an antenna. An opening is formed on the printed circuit board. The metal pad is electrically connected to the printed circuit board and is disposed on a side of the opening. The antenna includes a feeding part. The feeding part is disposed in the opening and contacts the metal pad.

### BACKGROUND OF THE INVENTION

1. Field of the Invention

The present invention relates to an antenna connecting module and a portable electronic device thereof, and more particularly, to an antenna connecting module capable of reducing occupied space and a portable electronic device thereof.

2. Description of the Prior Art

With improvement of communication technology, antennas are used in many fields. The most representative example is to install the antennas in portable wireless communication apparatuses, such as mobile phones and Bluetooth wireless devices, so as to transmit and receive radio signals. However, inner space of the portable wireless communication apparatuses is limited. The antennas disposed in the portable wireless communication apparatuses must be designed to occupy less space in order to conform the miniaturization trend of portable wireless communication devices. One of the greatest challenges is to minimize space occupied by the antennas due to inner space of the portable communication apparatuses is limited.

Because the antenna of the portable wireless communication apparatus must be disposed in somewhere without interference from electronic components, most of the antennas of the portable wireless communication apparatuses in the prior art are disposed in sound boxes of the portable wireless communication apparatuses by connecting feeding parts of the antennas with corresponding metal pads disposed on printed circuit boards. However, drawbacks of occupying inner space of the portable wireless communication apparatuses exist no matter the feeding part of the antenna is disposed on a side corresponding to a keypad or corresponding to a speaker on a printed circuit board. That is to say, if the feeding part of the antenna is disposed on a side corresponding to the keypad of the portable wireless communication on the printed circuit board, thickness of the printed circuit board increases due to additional thickness of a metal pad and the feeding part of the antenna so as to occupy space of the sound box in the portable wireless communication apparatus for strengthening sound intensity. Therefore, design of the sound box is limited, and there is a need to occupy extra space for containing additional thickness of the metal pad and the feeding part of the antenna on the printed circuit board. On the contrary, if the feeding part of the antenna is disposed on a side corresponding to the speaker on the printed circuit board of the portable wireless communication apparatus, such as being disposed on a back side of the portable wireless communication apparatus, the design not only has a drawback of occupying space like that the feeding part of the antenna is disposed on a side corresponding to the keypad on the printed circuit board as mentioned above, but also interferes capability of transmitting and receiving signals with the antenna disposed on the back side of the portable wireless communication apparatus whereon a user holds.

### SUMMARY OF THE INVENTION

According to the claimed invention, an antenna connecting module comprises a printed circuit board whereon an opening is formed, a metal pad electrically connected to the printed circuit board and disposed on a side of the opening, and an antenna comprising a feeding part, the feeding part being disposed in the opening and contacting the metal pad.

According to the claimed invention, a portable electronic device comprises a speaker and an antenna connecting module disposed on a side of the speaker. The antenna comprises a printed circuit board whereon an opening is formed, the opening being on a side corresponding to the speaker on the printed circuit board, a metal pad electrically connected to the printed circuit board and disposed on a side of the opening, and an antenna comprising a feeding part, the feeding part being disposed in the opening and contacting the metal pad.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exploded diagram of a portable electronic device according to a preferred embodiment of the present invention.

FIG. 2 is a sectional diagram of the portable electronic device in FIG. 1 according to the preferred embodiment of the present invention.

### DETAILED DESCRIPTION

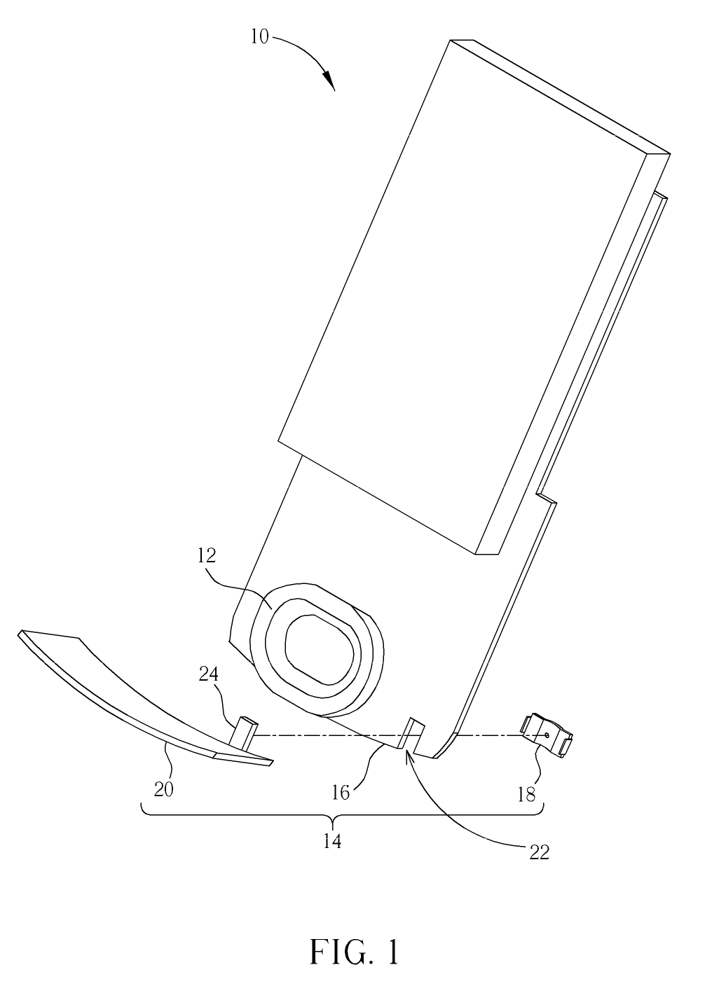

Please refer to FIG. 1. FIG. 1 is an exploded diagram of a portable electronic device 10 according to a preferred embodiment of the present invention. The portable electronic device 10 includes a speaker 12 and an antenna connecting module 14. The antenna connecting module 14 is disposed on a side of the speaker 12. As shown in FIG. 1, the antenna connecting module 14 includes a printed circuit board 16, a metal pad 18, and an antenna 20. An opening 22 is formed on the printed circuit board 16. The opening 22 is disposed on a side corresponding to the speaker 12 on the printed circuit board 16. The metal pad 18 electrically connected to the printed circuit board 16 is disposed on a side of the opening 22. The antenna 20 includes a feeding part 24. The feeding part 24 is disposed inside the opening 22 and contacts the metal pad 18.

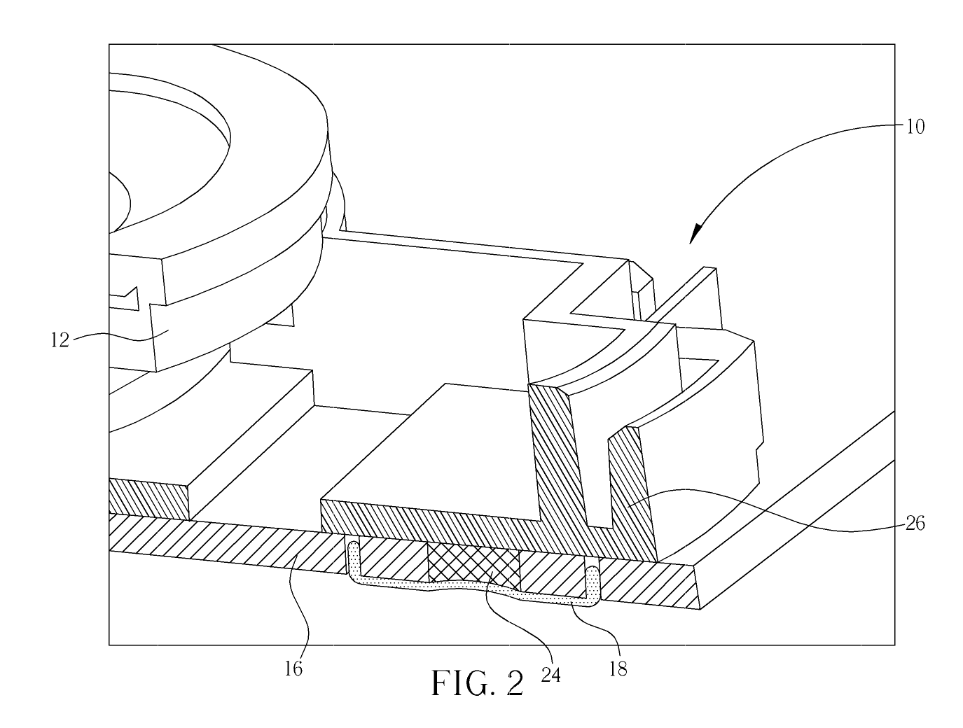

Please refer to FIG. 2. FIG. 2 is a sectional diagram of the portable electronic device 10 according to the preferred embodiment of the present invention. As shown in FIG. 2, the portable electronic device 10 further includes a flexible gasket 26. The flexible gasket 26 is disposed on a side of the opening 22 different from a side whereon the metal pad 18 is disposed, and the flexible gasket 26 covers the feeding part 24 for preventing sound generated by the speaker 12 from escaping via the opening 22. In this embodiment, the flexible gasket 26 can be made of rubber material. As shown in FIG. 2, the feeding part 24 of the antenna 20 is disposed inside the opening 22 of the printed circuit board 16. Therefore, total thickness of the antenna connecting module 14 is reduced as combined thickness of the metal pad 18 and the printed circuit board 16, not as combined thickness of the feeding part 24 of the antenna 20, the metal pad 18, and the printed circuit board 16. A sound box of the portable electronic device 10 used for strengthening sound intensity of the speaker 12 is not occupied by the feeding part 24 of the antenna 20 due to the feeding part 24 of the antenna 20 being disposed inside the opening 22 of the printed circuit board 16. Thus, it increases mechanical design flexibility of the sound box of the speaker 12 and of inner space of the portable electronic device 10. In addition, the metal pad 18 is connected to the printed circuit board 16, and the connecting mechanism is not limited to the method as shown in FIG. 2. The other common connecting mechanisms well known in the prior art can be used for application. For example, the metal pad 18 can be connected to the printed circuit board 16 by surface mount device (SMD) technology.

It should be mentioned that the opening 22 is formed on a side corresponding to the speaker 12 on the printed circuit board 16, and the side of the sound box of the portable electronic device 10 is used for resonating sound generated by the speaker 12 so as to strengthen sound intensity of the speaker 12. Therefore, if there is no sound-proof processing for the opening 22, sound generated by the speaker 12 will escape out via the opening 22 so as to influence quality of the speaker 12. As mentioned above, the flexible gasket 26 is used for preventing sound generated by the speaker 12 from escaping via the opening 22 by covering the feeding part 24 of the antenna 20. The sound-proof processing for the opening 22 of the present invention is not limited to the above-mentioned method and depends on actual demand. For example, the present invention can be achieved by integrating the feeding part 24 of the antenna 20 into the opening 22 closely. Accordingly, the flexible gasket 26 has not to be disposed on a side of the opening 22 different from a side whereon the metal pad 18 is disposed. That is to say, the flexible gasket 26 can be omitted selectively. Furthermore, the feeding part 24 of the antenna 20 is not limited to a rectangular prism as shown in FIG. 1. For example, the feeding part 24 of the antenna 20 can be formed of other structures, such as a cylinder.

In summary, the feeding part of the antenna is disposed on the printed circuit board in the prior art. However, the inner space of the portable electronic device is occupied by the feeding part of the antenna in the prior art. Not only design of the inner space of the portable electronic device is occupied, but whole dimension of the portable electronic device is also increased in the prior art. In contrast to the prior art, the opening formed on the printed circuit board of the present invention is used for containing the feeding part of the antenna. Therefore, total thickness of the antenna connecting module is reduced as combined thickness of the metal pad and the printed circuit board, instead of combined thickness of the feeding part of the antenna, the metal pad, and the printed circuit board. The feeding part of the antenna can be disposed inside the opening of the printed circuit board so as to avoid occupying the inner space of the portable electronic device. The present invention not only increases flexibility for applying the inner space of the portable electronic device and extends space of the printed circuit board for disposing components, but also designs shapes and dimensions of the mobile phones without limitation of the antenna.

Those skilled in the art will readily observe that numerous modifications and alterations of the device and method may be made while retaining the teachings of the invention.

What is claimed is:

1. An antenna connecting module comprising:
a printed circuit board whereon an opening is formed;
a metal pad electrically connected to the printed circuit board and disposed on a side of the opening; and
an antenna comprising a feeding part, the feeding part being disposed in the opening and contacting the metal pad.

2. The antenna connecting module of claim 1, wherein the metal pad is connected to the printed circuit board by surface mount device (SMD) technology.

3. The antenna connecting module of claim 1, wherein the opening is formed on a side corresponding to a speaker on the printed circuit board.

4. The antenna connecting module of claim 3 further comprising a flexible gasket disposed on a side of the opening different from a side whereon the metal pad is disposed and covering the feeding part for preventing sound generated by the speaker from escaping via the opening.

5. The antenna connecting module of claim 4, wherein the flexible gasket is made of rubber material.

6. The antenna connecting module of claim 3, wherein the feeding part is closely integrated into the opening.

7. A portable electronic device comprising:
a speaker; and
an antenna connecting module disposed on a side of the speaker, the antenna comprising:
a printed circuit board whereon an opening is formed, the opening being on a side corresponding to the speaker on the printed circuit board;
a metal pad electrically connected to the printed circuit board and disposed on a side of the opening; and
an antenna comprising a feeding part, the feeding part being disposed in the opening and contacting the metal pad.

8. The portable electronic device of claim 7, wherein the metal pad is connected to the printed circuit board by surface mount device (SMD) technology.

9. The portable electronic device of claim 7 further comprising a flexible gasket disposed on a side of the opening different from a side whereon the metal pad is disposed and covering the feeding part for preventing sound generated by the speaker from escaping via the opening.

10. The portable electronic device of claim 9, wherein the flexible gasket is made of rubber material.

11. The portable electronic device of claim 7, wherein the feeding part is closely integrated into the opening.
